(19) United States
(12) Patent Application Publication
(10) Pub. No.: US 2023/0231635 A1
(43) Pub. Date: Jul. 20, 2023

(54) POSITION ESTIMATION SYSTEM, FIXED RADIO APPARATUS, AND MOBILE RADIO APPARATUS

(71) Applicant: Panasonic Intellectual Property Management Co., Ltd., Osaka (JP)

(72) Inventors: Mei OKAMOTO, Kanagawa (JP); Naganori SHIRAKATA, Kanagawa (JP); Tomohiro MURATA, Kanagawa (JP); Hiroshi TAKAHASHI, Kanagawa (JP); Yohei MORISHITA, Kanagawa (JP)

(21) Appl. No.: 18/189,535

(22) Filed: Mar. 24, 2023

Related U.S. Application Data
(63) Continuation of application No. PCT/JP2021/026007, filed on Jul. 9, 2021.

(30) Foreign Application Priority Data
Sep. 29, 2020 (JP) 2020-163244

(51) Int. Cl. H04B 17/27; H04B 17/318; G01S 5/02

(52) U.S. Cl. CPC H04B 17/27; H04B 17/318; G01S 5/02525

(57) ABSTRACT

A mobile radio apparatus transmits to a plurality of fixed radio apparatuses, a fingerprint that indicates a reception strength distribution of radio signals from the plurality of fixed radio apparatuses. Each of the plurality of fixed radio apparatuses in which a learning model is installed inputs the fingerprint to the learning model and transmits a degree of proximity of the mobile radio apparatus output from the learning model to another one or more of the plurality of fixed radio apparatuses, and determines a position of the mobile radio apparatus, based on a first degree of proximity output from the learning model and a second degree of proximity received from the other one or more of the plurality of fixed radio apparatuses.

### TECHNICAL FIELD

The present disclosure relates to a position estimation system, a fixed radio apparatus, and a mobile radio apparatus.

### BACKGROUND ART

With the recent development of radio communication technology and widespread use of radio terminals, position estimation for radio terminals by using radio communication technology has been performed. Reception strength information obtained through radio communication is affected by the surrounding environment and varies, and therefore, there has been an increasing demand for a position estimation method that is highly versatile in a changing environment.

For example, PTL 1 proposes a system that estimates the position of a terminal by using received-electromagnetic wave information about an electromagnetic wave obtained from the terminal that receives the electromagnetic wave and using object recognition information obtained by using a camera.

### CITATION LIST

### Patent Literature

PTL 1

Japanese Patent Application Laid-Open No. 2019-174164

### SUMMARY OF INVENTION

However, the system described in PTL 1 requires a camera for obtaining object recognition information and is costly.

One non-limiting and exemplary embodiment facilitates providing a position estimation system, a mobile radio apparatus, and a fixed radio apparatus each enabling position estimation for a mobile radio apparatus at low cost.

A position estimation system according to an exemplary embodiment of the present disclosure, includes: a mobile radio apparatus; and a plurality of fixed radio apparatuses in which a learning model is installed, in which the mobile radio apparatus transmits, to the plurality of fixed radio apparatuses, a fingerprint that indicates a reception strength distribution of radio signals from the plurality of fixed radio apparatuses, and each of the plurality of fixed radio apparatuses inputs the fingerprint to the learning model and transmits a degree of proximity of the mobile radio apparatus output from the learning model to another one or more of the plurality of fixed radio apparatuses, and each of the plurality of fixed radio apparatuses determines a position of the mobile radio apparatus, based on a first degree of proximity output from the learning model and a second degree of proximity received from the other one or more of the plurality of fixed radio apparatuses.

A fixed radio apparatus according to an exemplary embodiment of the present disclosure, includes: a communication circuit that receives from a mobile radio apparatus, a fingerprint that indicates a reception strength distribution of a radio signal from the fixed radio apparatus and a radio signal from another fixed radio apparatus; and a control circuit that inputs the fingerprint to a learning model and obtains a first degree of proximity of the mobile radio apparatus to the fixed radio apparatus, in which the communication circuit receives a second degree of proximity of the mobile radio apparatus to the other fixed radio apparatus, the second degree of proximity being obtained by the other fixed radio apparatus by inputting the fingerprint to a learning model, and the control circuit determines a position of the mobile radio apparatus, based on the first degree of proximity and the second degree of proximity.

A mobile radio apparatus according to an exemplary embodiment of the present disclosure, includes: a communication circuit that transmits to a plurality of fixed radio apparatuses, a fingerprint that indicates a reception strength distribution of radio signals from the plurality of fixed radio apparatuses, and receives from the plurality of fixed radio apparatuses, degrees of proximity of the mobile radio apparatus to the plurality of fixed radio apparatuses, the degrees of proximity being obtained by the plurality of fixed radio apparatuses by inputting the fingerprint to respective learning models; and a control circuit that determines a position of the mobile radio apparatus, based on the degrees of proximity.

It should be noted that general or specific embodiments may be implemented as a system, an apparatus, a method, an integrated circuit, a computer program, a recording medium, or any selective combination thereof.

According to an exemplary embodiment of the present disclosure, the position of a mobile radio apparatus can be estimated at low cost.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a diagram illustrating an example configuration of a position estimation system according to an embodiment;

FIG. 2 is a diagram illustrating an example fingerprint;

FIG. 3 is a diagram for explaining example general operations for position estimation in the position estimation system;

FIG. 4 is a diagram illustrating an example block configuration of a radio terminal;

FIG. 5 is a diagram illustrating an example block configuration of a controller;

FIG. 6 is a diagram illustrating an example structure of a BC packet;

FIG. 7 is a flowchart illustrating an example overall operation in the position estimation system;

FIG. 8 is a flowchart illustrating an example operation of a data obtaining process;

FIG. 9 is a flowchart illustrating an example general operation of a position estimation process;

FIG. 10 is a flowchart illustrating an example general operation of a model update process;

FIG. 11 is a flowchart illustrating an example operation of the position estimation process;

FIG. 12 is a sequence chart illustrating example operations in the position estimation system; and

FIG. 13 is a flowchart illustrating an example update operation of updating a position estimation model.

### DESCRIPTION OF EMBODIMENTS

Hereinafter, an embodiment of the present disclosure will be described in detail with reference to the accompanying drawings as appropriate. However, more detailed description than necessary may be omitted. For example, detailed descriptions of already well-known matters and repeated descriptions for substantially the same configuration may be omitted. This is to prevent the following description from becoming unnecessarily redundant and to facilitate understanding for those skilled in the art.

Note that, the accompanying drawings and the following description are provided so that those skilled in the art understand the present embodiment sufficiently, and are not intended to limit the subject matters recited in the claims.

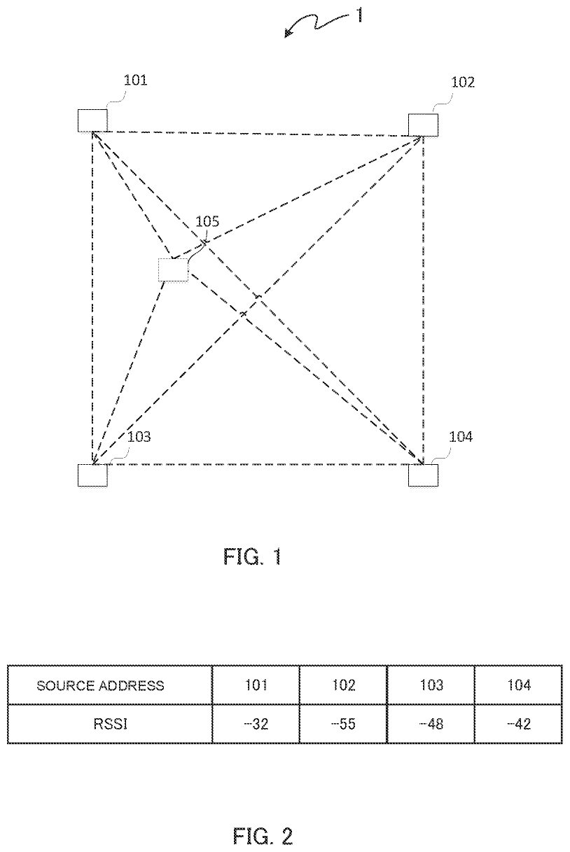

FIG. 1 is a diagram illustrating an example configuration of position estimation system 1 according to an embodiment. As illustrated in FIG. 1, position estimation system 1 includes radio terminals 101 to 105. The dotted lines illustrated in FIG. 1 represent radio links for connections between radio terminals 101 to 105. Radio terminals 101 to 105 form a mesh network. Position estimation system 1 includes three processes, namely, a data obtaining process, a position estimation process, and a model update process.

Among radio terminals 101 to 105, radio terminals 101 to 104 are radio terminals that are fixed in a place such as a workplace. In contrast, radio terminal 105 is, for example, a mobile radio terminal carried by a user. Radio terminal 105 that is a mobile radio terminal is a radio terminal that is a position estimation target.

Radio terminals 101 to 105 may be referred to as nodes or radio apparatuses. Radio terminals 101 to 104 that are fixed in an installation place may be referred to as anchor nodes or fixed radio apparatuses. Radio terminal 105 that is a mobile radio terminal may be referred to as a mobile node, a target, or a mobile radio apparatus.

Position estimation system 1 is applied to, for example, a site of work such as a factory. For example, radio terminals 101 to 104, which are anchor nodes, are fixed to workbenches installed for respective processes in the factory. Radio terminal 105, which is a mobile node, is carried by a worker (user) who moves between the processes and carries out work at the workbenches for the respective processes.

Position estimation system 1 determines when radio terminal 105, which is a mobile node, is located in the vicinity of which of radio terminals 101 to 104, which are anchor nodes, by using artificial intelligence such as machine learning. Accordingly, position estimation system 1 can track when the worker carries out work for which process. In other words, estimation is determination.

Radio terminals 101 to 105 may transmit an estimated position of radio terminal 105 to, for example, a production management server (not illustrated).

The production management server may analyze a received movement path of radio terminal 105. That is, the production management server may analyze activities of the worker carrying radio terminal 105 and calculate processes for improving the work efficiency of the worker.

The configuration of position estimation system 1 is not limited to the example illustrated in FIG. 1. For example, the number of anchor nodes may be one or more. The number of mobile nodes may be two or more.

A general operation of the data obtaining process in position estimation system 1 will be described. FIG. 2 is a diagram illustrating an example fingerprint at radio terminal 105. The fingerprint indicates the reception strength distribution, at radio terminal 105, of radio signals from other radio terminals 101 to 104. Reception strengths in the reception strength distribution may be expressed by, for example, RSSI (Received Signal Strength Indicator). The fingerprint may be referred to as a fingerprint vector.

Each of radio terminals 101 to 104 transmits a BC (BroadCast) packet. Radio terminal 105 that receives the BC packet measures the RSSI of the BC packet. Radio terminal 105 stores the source address of the source node included in the BC packet and the measured RSSI in association with each other.

For example, radio terminal 105 measures the RSSIs of the BC packets respectively transmitted from radio terminals 101 to 104. Radio terminal 105 stores the source addresses of radio terminals 101 to 104 and the measured RSSIs in association with each other as a fingerprint illustrated in FIG. 2.

Each of radio terminals 101 to 104 transmits a BC packet at predetermined intervals. A fingerprint stored on radio terminal 105 changes as radio terminal 105 moves. For example, when radio terminal 105 comes closer to radio terminal 101, which is an anchor node, as illustrated in FIG. 1, an RSSI corresponding to radio terminal 101 becomes larger than RSSIs corresponding to other radio terminals 102 to 104. Therefore, the position of radio terminal 105, which is a mobile node, can be estimated from the pattern of the fingerprint at radio terminal 105. Note that the predetermined intervals may be changed as desired.

Radio terminal 105 also transmits a BC packet similarly to radio terminals 101 to 104. Each of radio terminals 101 to 104 receives BC packets from the other radio terminals of radio terminals 101 to 105 and stores a fingerprint similarly to radio terminal 105.

A general operation of the position estimation process in position estimation system 1 will be described. In each of radio terminals 101 to 104, which are anchor nodes, for example, a learning model based on, for example, machine learning is installed. The learning model installed in each of radio terminals 101 to 104 calculates, in response to input of a fingerprint broadcast from radio terminal 105, a proximity probability that indicates the degree of proximity of radio terminal 105.

The proximity probability is, for example, a value from 0 to 1, and a value closer to 1 indicates that radio terminal 105, which is a mobile node, is closer to a radio terminal that outputs the value closer to 1 among radio terminals 101 to 104, which are anchor nodes. Hereinafter, the learning model may be referred to as a position estimation model.

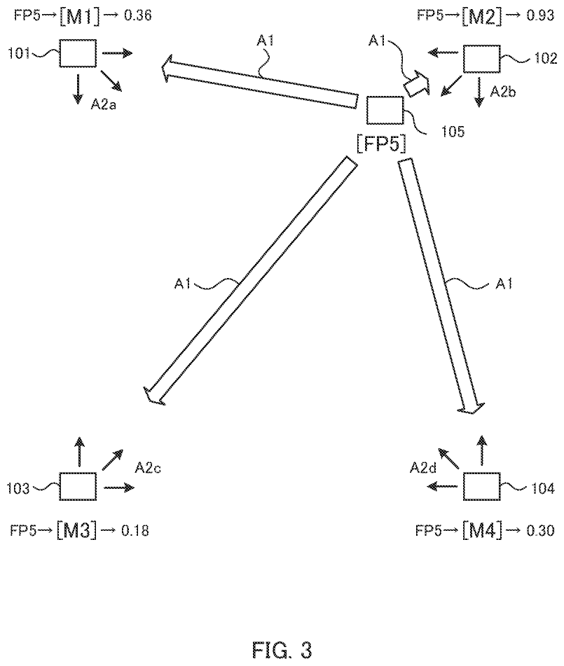

FIG. 3 is a diagram for explaining example general operations for position estimation in position estimation system 1. In FIG. 3, [M1] represents the position estimation model installed in radio terminal 101. [M2] represents the position estimation model installed in radio terminal 102. [M3] represents the position estimation model installed in radio terminal 103. [M4] represents the position estimation model installed in radio terminal 104. In FIG. 3, [FP5] represents a fingerprint at radio terminal 105.

In FIG. 3, FP5 to the left of [M1] to [M4] is fingerprint FP5 input to position estimation models M1 to M4. Numbers to the right of [M1] to [M4] are proximity probabilities respectively calculated by position estimation models M1 to M4.

Position estimation model M1 installed in radio terminal 101 is a learning model trained by using as training data, fingerprint FP5 at radio terminal 105 obtained when radio terminal 105 comes closer to radio terminal 101. Therefore, when radio terminal 105 comes closer to radio terminal 101, a proximity probability output from position estimation model M1 comes closer to 1. When radio terminal 105 moves away from radio terminal 101, a proximity probability output form position estimation model M1 comes closer to 0.

Position estimation model M2 installed in radio terminal 102 is a learning model trained by using as training data, fingerprint FP5 at radio terminal 105 obtained when radio terminal 105 comes closer to radio terminal 102. Therefore, when radio terminal 105 comes closer to radio terminal 102, a proximity probability output from position estimation model M2 comes closer to 1. When radio terminal 105 moves away from radio terminal 102, a proximity probability output form position estimation model M2 comes closer to 0.

Position estimation model M3 installed in radio terminal 103 is a learning model trained by using as training data, fingerprint FP5 at radio terminal 105 obtained when radio terminal 105 comes closer to radio terminal 103. Therefore, when radio terminal 105 comes closer to radio terminal 103, a proximity probability output from position estimation model M3 comes closer to 1. When radio terminal 105 moves away from radio terminal 103, a proximity probability output form position estimation model M3 comes closer to 0.

Position estimation model M4 installed in radio terminal 104 is a learning model trained by using as training data, fingerprint FP5 at radio terminal 105 obtained when radio terminal 105 comes closer to radio terminal 104. Therefore, when radio terminal 105 comes closer to radio terminal 104, a proximity probability output from position estimation model M4 comes closer to 1. When radio terminal 105 moves away from radio terminal 104, a proximity probability output form position estimation model M4 comes closer to 0.

The general operations illustrated in FIG. 3 will be described. Radio terminal 105, which is a mobile node, broadcasts fingerprint FP5 as represented by arrows A1 in FIG. 3. Radio terminal 105 broadcasts fingerprint FP5 at predetermined intervals.

Radio terminal 101, which is an anchor node, inputs fingerprint FP5 broadcast from radio terminal 105, which is a mobile node, to position estimation model M1 and calculates a proximity probability that is the probability of the proximity of radio terminal 105 to radio terminal 101. In the example illustrated in FIG. 3, position estimation model M1 outputs 0.36.

Radio terminal 102, which is an anchor node, inputs fingerprint FP5 broadcast from radio terminal 105, which is a mobile node, to position estimation model M2 and calculates a proximity probability that is the probability of the proximity of radio terminal 105 to radio terminal 102. In the example illustrated in FIG. 3, position estimation model M2 outputs 0.93.

Radio terminal 103, which is an anchor node, inputs fingerprint FP5 broadcast from radio terminal 105, which is a mobile node, to position estimation model M3 and calculates a proximity probability that is the probability of the proximity of radio terminal 105 to radio terminal 103. In the example illustrated in FIG. 3, position estimation model M3 outputs 0.18.

Radio terminal 104, which is an anchor node, inputs fingerprint FP5 broadcast from radio terminal 105, which is a mobile node, to position estimation model M4 and calculates a proximity probability that is the probability of the proximity of radio terminal 105 to radio terminal 104. In the example illustrated in FIG. 3, position estimation model M4 outputs 0.30.

In the example illustrated in FIG. 3, radio terminal 105, which is a mobile node, is proximate to radio terminal 102, which is an anchor node. Therefore, the proximity probability (0.93) output from position estimation model M2 is highest.

In response to calculating the proximity probabilities, radio terminals 101 to 104, which are anchor nodes, broadcast the calculated proximity probabilities as represented by arrows A2a to A2d in FIG. 3, respectively. Accordingly, each of radio terminals 101 to 105 obtains (shares) the proximity probabilities respectively calculated by radio terminals 101 to 104.

For example, radio terminal 101 obtains the proximity probabilities calculated by radio terminals 102 to 104. Radio terminal 102 obtains the proximity probabilities calculated by radio terminals 101, 103, and 104. Radio terminal 103 obtains the proximity probabilities calculated by radio terminals 101, 102, and 104. Radio terminal 104 obtains the proximity probabilities calculated by radio terminals 101 to 103. Radio terminal 105 obtains the proximity probabilities calculated by radio terminals 101 to 104.

Each of radio terminals 101 to 105 estimates the position of radio terminal 105 on the basis of the obtained proximity probabilities. For example, each of radio terminals 101 to 105 infers that radio terminal 105, which is a mobile node, is located in the vicinity of a radio terminal that calculates the highest proximity probability among radio terminals 101 to 104, which are anchor nodes.

In the example illustrated in FIG. 3, the proximity probability (0.93) calculated by radio terminal 102 is highest. Therefore, each of radio terminals 101 to 105 infers that radio terminal 105, which is a mobile node, is located in the vicinity of radio terminal 102.

Position estimation system 1 performs the above-described process at predetermined intervals and estimates the position of radio terminal 105, which is a mobile node, as needed.

A general operation of the model update process in position estimation system 1 will be described. Position estimation system 1 may estimate the position of radio terminal 105, which is a mobile node, and further update the position estimation models. That is, position estimation system 1 may update the position estimation models after position estimation system 1 is put in operation. Accordingly, position estimation system 1 can build the position estimation models that are suitable for operations, such as the installation state of position estimation system 1.

A radio terminal that calculates the highest proximity probability among radio terminals 101 to 104 may update the weight (also referred to as a parameter) of the position estimation model thereof among position estimation models M1 to M4 when, for example, a certain condition is met.

In a case of the example illustrated in FIG. 3, radio terminal 102 calculates the highest proximity probability. Therefore, in the case of the example illustrated in FIG. 3, when a certain condition is met, radio terminal 102 updates position estimation model M2.

For example, when the highest proximity probability calculated by radio terminal 102 is greater than or equal to a first specified value and the proximity probabilities calculated by other radio terminals 101, 103, and 104 are less than a second specified value, radio terminal 102 stores as training data, fingerprint FP5 input to position estimation model M2.

Specifically, when the proximity probability calculated by radio terminal 102 is greater than or equal to 0.8 and the proximity probabilities calculated by other radio terminals 101, 103, and 104 are less than 0.4, radio terminal 102 stores as training data, fingerprint FP5 input to position estimation model M2. Radio terminal 102 uses the stored training data to update position estimation model M2.

When the proximity probability calculated by radio terminal 102 is greater than or equal to the first specified value and the proximity probabilities calculated by other radio terminals 101, 103, and 104 are less than the second specified value, radio terminal 105, which is a mobile node, can be regarded as being located within a predetermined distance of radio terminal 102 and being located a predetermined distance or more from radio terminals 101, 103, and 104.

Therefore, fingerprint FP5 that is input to position estimation model M2 of radio terminal 102 can be regarded as having a high reliability level (for example, a reliability level 1) as a fingerprint indicating that radio terminal 105, which is a mobile node, is located close to radio terminal 102.

On the other hand, when the proximity probability calculated by radio terminal 102 is less than the first specified value or when the proximity probabilities calculated by other radio terminals 101, 103, and 104 are greater than or equal to the second specified value, radio terminal 105, which is a mobile node, can be regarded as not being located within the predetermined distance of radio terminal 102 or not being located the predetermined distance or more from radio terminal 101, 103, or 104.

Therefore, fingerprint FP5 that is input to position estimation model M2 of radio terminal 102 can be regarded as having a low reliability level (for example, a reliability level 0) as a fingerprint indicating that radio terminal 105, which is a mobile node, is located close to radio terminal 102.

Radio terminal 102 may update position estimation model M2 by using fingerprint FP5 having a high reliability level (for example, fingerprint FP5 having a reliability level 1) as training data.

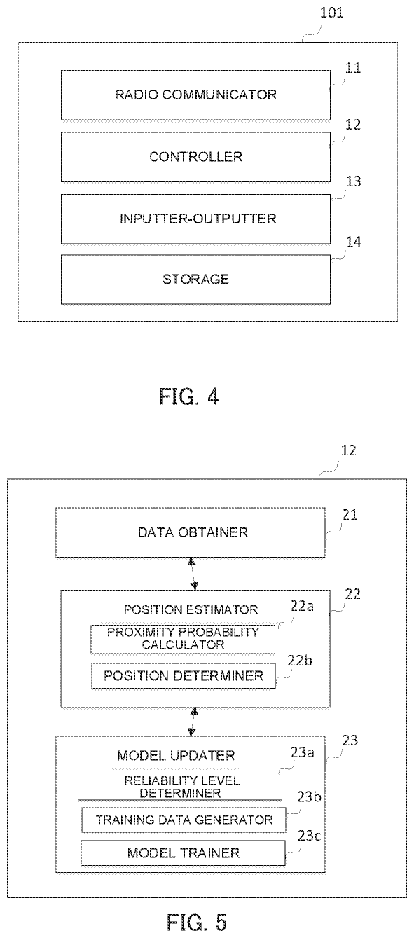

FIG. 4 is a diagram illustrating an example block configuration of radio terminal 101. Radio terminals 101 to 105 have the same block configuration, and therefore, the block configuration of radio terminal 101 will be described with reference to FIG. 4.

As illustrated in FIG. 4, radio terminal 101 includes radio communicator 11, controller 12, inputter-outputter 13, and storage 14.

Radio communicator 11 performs radio communication with other radio terminals 102 to 105. Radio communicator 11 outputs data of a received radio signal to controller 12. Note that radio communicator 11 may communicate with the production management server (not illustrated).

Radio communicator 11 may perform radio communication on the basis of, for example, the specified low power communication using the 920 MHz band, ZigBee (IEEE 802.15.4) using the 2.4 GHz band, Bluetooth (registered trademark), a radio LAN (IEEE 802.11b/g/n), a radio LAN (IEEE 802.11a/ac) using the 5 GHz band, DSRC, a radio LAN (IEEE 802.11ad) using the 60 GHz band, premises PHS, LTE, or 5G.

IEEE stands for Institute of Electrical and Electronics Engineers. LAN stands for Local Area Network. DSRC stands for Dedicated Short Range Communications. PHS stands for Personal Handy-phone System. LTE stands for Long Term Evolution. 5G stands for 5th Generation.

Controller 12 controls the entirety of radio terminal 101. Controller 12 may be configured as, for example, a CPU (central processing unit).

Controller 12 controls, for example, transmission and reception of packets. Controller 12 measures the RSSIs of BC packets transmitted from other radio terminals 102 to 105 and stores a fingerprint in storage 14. Controller 12 uses the stored fingerprint (training data) to update the position estimation model.

Controller 12 uses the position estimation model to calculate the proximity probability of radio terminal 105, which is a mobile node. Controller 12 compares the calculated proximity probability of radio terminal 105 with proximity probabilities transmitted from other radio terminals 102 to 104, which are anchor nodes, and estimates the position of radio terminal 105. Controller 12 may transmit estimated position information about radio terminal 105 to, for example, the external production management server.

Controller 12 determines which of the proximity probabilities calculated by radio terminals 101 to 104 is the highest proximity probability, and when the certain condition (the condition explained with reference to FIG. 3) is met, stores (adds) the fingerprint received from radio terminal 105, which is a mobile node, in storage 14 as training data. Controller 12 uses the fingerprint stored in storage 14 to update the position estimation model.

Inputter-outputter 13 includes an input device including a switch and a key apparatus. Inputter-outputter 13 includes a sensor device including an acceleration sensor and a motion sensor. Inputter-outputter 13 includes an output device including an LED (light-emitting diode), a display, and a speaker.

In storage 14, a program for controller 12 to operate is stored. In storage 14, for example, data for controller 12 to perform a calculation process or data for controller 12 to control radio communicator 11 and so on in radio terminal 101 is stored. For example, in storage 14, data including a node list, a fingerprint, training data, and the position estimation model is stored.

FIG. 5 is a diagram illustrating an example block configuration of controller 12. Radio terminals 101 to 105 includes the same controller, and therefore, the block configuration of controller 12 of radio terminal 101 will be described with reference to FIG. 5.

Controller 12 controls radio communicator 11, inputter-outputter 13, and storage 14 illustrated in FIG. 4 to implement, for example, three functions of the data obtaining process, the position estimation process, and the model update process. Controller 12 includes data obtainer 21 that implements the function of the data obtaining process, position estimator 22 that implements the function of the position estimation process, and model updater 23 that implements the function of the model update process.

Data obtainer 21 receives via radio communicator 11, a fingerprint transmitted from radio terminal 105, which is a mobile node, at predetermined intervals. Data obtainer 21 receives via radio communicator 11, proximity probabilities calculated by other radio terminals 102 to 104.

Position estimator 22 includes proximity probability calculator 22a and position determiner 22b.

Proximity probability calculator 22a inputs a fingerprint at radio terminal 105, which is a mobile node, received by data obtainer 21 to the position estimation model stored in storage 14 and calculates the proximity probability that is the probability of the proximity of radio terminal 105 to radio terminal 101.

Position determiner 22b compares the proximity probability calculated by proximity probability calculator 22a with the proximity probabilities at other radio terminals 102 to 104 received by data obtainer 21. On the basis of the result of comparison, position determiner 22b determines to which of radio terminals 101 to 104, which are anchor nodes, radio terminal 105, which is a mobile node, is present close at the time when the fingerprint is received.

Model updater 23 includes reliability level determiner 23a, training data generator 23b, and model trainer 23c.

Reliability level determiner 23a uses the proximity probability calculated by position estimator 22 to determine the reliability level of the fingerprint input to the position estimation model. The reliability level of the fingerprint can be regarded as the reliability level of the proximity probability output by the position estimation model or the reliability level of the estimated position.

Training data generator 23b generates training data, which is the fingerprint input to the position estimation model, on the basis of the result of determination by reliability level determiner 23a. Training data generator 23b stores (adds) the generated training data in storage 14.

Model trainer 23c performs retraining by using the training data stored in storage 14 and updates the position estimation model.

Model trainer 23c may obtain training data and generate the position estimation model, for example, after position estimation system 1 is installed in a factory and before position estimation for radio terminal 105, which is a mobile node, is put in operation, which will be described below.

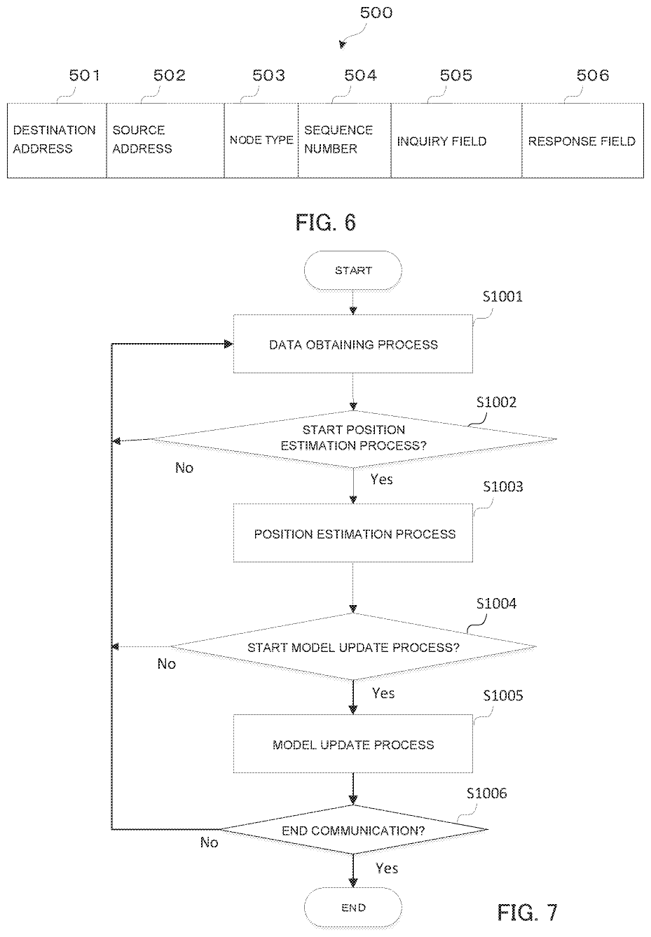

FIG. 6 is a diagram illustrating an example structure of BC packet 500. Radio terminals 101 to 105 broadcast, for example, BC packet 500 illustrated in FIG. 6.

As illustrated in FIG. 6, BC packet 500 has regions of destination address 501, source address 502, node type 503, sequence number 504, inquiry field 505, and response field 506.

In destination address 501, the address of a radio terminal to which BC packet 500 is transmitted is stored. For example, in destination address 501, a broadcast address (for example, all ones) is stored.

In source address 502, the address of a radio terminal that transmits BC packet 500 is stored. The address of the radio terminal may be, for example, a MAC (Media Access Control) address.

In node type 503, node type information indicating whether the radio terminal that transmits BC packet 500 is an anchor node or a mobile node is stored. For example, when radio terminals 101 to 104 transmit BC packet 500, node type information indicating an anchor node is stored in node type 503. When radio terminal 105 transmits BC packet 500, node type information indicating a mobile node is stored in node type 503.

Node type information may be set by a user using the inputter-outputter, such as a key apparatus to which functions are assigned or a keyboard, upon for example, initial setting. The set node type information is stored in the storage of the radio terminal.

Node type information may be set in a radio terminal on the basis of, for example, a signal from the inputter-outputter, such as an acceleration sensor. For example, the controller of a radio terminal determines whether the radio terminal is an anchor node or a mobile node on the basis of a signal from the acceleration sensor. In response to determining that the radio terminal is an anchor node, the controller of the radio terminal stores node type information indicating an anchor node in the storage. In response to determining that the radio terminal is a mobile node, the controller of the radio terminal stores node type information indicating a mobile node in the storage.

In sequence number 504, a sequence number indicating the number (or ID) of the packet is stored.

In inquiry field 505, data concerning an inquiry to other radio terminals (inquiry information) is stored.

For example, radio terminal 105, which is a mobile node and which is a position estimation target, stores a fingerprint at radio terminal 105 in inquiry field 505 and broadcasts BC packet 500 to other radio terminals 101 to 104 (see, for example, arrows A1 in FIG. 3).

In response field 506, data concerning a response to an inquiry from another radio terminal (response information) is stored.

For example, when a fingerprint at radio terminal 105, which is a mobile node, is stored in inquiry field 505, each of radio terminals 101 to 104, which are anchor nodes, inputs the fingerprint stored in inquiry field 505 to the position estimation model and calculates the proximity probability of radio terminal 105 (for example, 0.36, 0.93, 0.18, and 0.30 illustrated in FIG. 3).

Radio terminal 101, which is an anchor node, stores the calculated proximity probability (0.36) in response field 506 and broadcasts BC packet 500 (for example, see arrows A2a in FIG. 3). Radio terminal 102, which is an anchor node, stores the calculated proximity probability (0.93) in response field 506 and broadcasts BC packet 500 (for example, see arrows A2b in FIG. 3). Radio terminal 103, which is an anchor node, stores the calculated proximity probability (0.18) in response field 506 and broadcasts BC packet 500 (for example, see arrows A2c in FIG. 3). Radio terminal 104, which is an anchor node, stores the calculated proximity probability (0.30) in response field 506 and broadcasts BC packet 500 (for example, see arrows A2d in FIG. 3).

Radio terminals 101 to 104, which are anchor nodes, store in response field 506, the source address (that is, the address of radio terminal 105) and the sequence number of BC packet 500 that includes the fingerprint in inquiry field 505. Accordingly, each of radio terminals 101 to 105 can determine for which fingerprint at which mobile node, the received proximity probability is calculated.

FIG. 7 is a flowchart illustrating an example overall operation in position estimation system 1. The operation in position estimation system 1 may be divided into three processes, namely, the data obtaining process, the position estimation process, and the model update process.

In step S1001, each of radio terminals 101 to 105 transmits a BC packet for RSSI measurement. As the BC packet, BC packet 500 illustrated in FIG. 6 may be used. In inquiry field 505, information indicating that the BC packet is a packet for RSSI measurement may be included.

Each of radio terminals 101 to 105 receives the BC packets for RSSI measurement and generates a fingerprint. Each of radio terminals 101 to 105 stores the generated fingerprint in the storage.

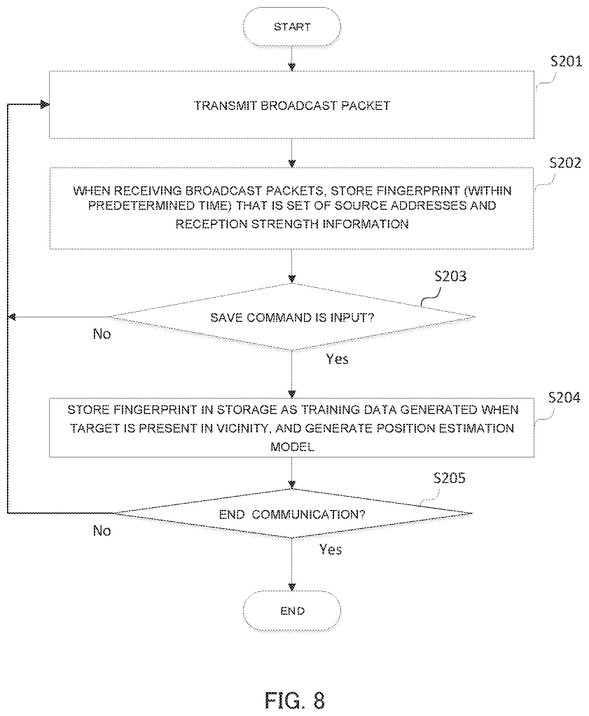

In response to input of a save command by a user (for example, the installer of position estimation system 1) operating the inputter-outputter, such as a switch, each of radio terminals 101 to 105 stores the generated fingerprint in the storage as training data, which will be described with reference to FIG. 8.

In step S1002, each of radio terminals 101 to 104, which are anchor nodes, determines whether to start the position estimation process. For example, each of radio terminals 101 to 104 determines whether to start the position estimation process, on the basis of whether a BC packet that includes a fingerprint at radio terminal 105 is received from radio terminal 105, which is a mobile node. When the position estimation process is not to be started (“No” in S1002), each of radio terminals 101 to 104 causes the process to return to step S1001. When the position estimation process is to be started (“Yes” in S1002), each of radio terminals 101 to 104 causes the process to proceed to step S1003.

In step S1003, each of radio terminals 101 to 104, which are anchor nodes, inputs the fingerprint included in the BC packet to the position estimation model and calculates the proximity probability of radio terminal 105, which is a mobile node. Each of radio terminals 101 to 104, which are anchor nodes, broadcasts the calculated proximity probability and obtains (shares) the proximity probabilities calculated by the other radio terminals of radio terminals 101 to 104, which are anchor nodes. Each of radio terminals 101 to 104, which are anchor nodes, compares the proximity probabilities calculated by the respective radio terminals with each other and performs position estimation to determine to which of radio terminals 101 to 104, radio terminal 105, which is a mobile node, is present closest.

In step S1004, each of radio terminals 101 to 104, which are anchor nodes, determines whether to start the model update process after position estimation in S1003. For example, each radio terminal of radio terminals 101 to 104, which are anchor nodes, determines whether to start the model update process, on the basis of whether the radio terminal calculates the highest proximity probability. When the model update process is not to be started (“No” in S1004), radio terminals determining that the model update process is not to be started among radio terminals 101 to 104 cause the process to return to step S1001. When the model update process is to be started (“Yes” in S1004), a radio terminal determining that the model update process is to be started among radio terminals 101 to 104 causes the process to proceed to step S1005.

In step S1005, the radio terminal determining that the model update process is to be started among radio terminals 101 to 104, which are anchor nodes, performs the model update process. The radio terminal that performs a model update among radio terminals 101 to 104 uses the proximity probability shared in step S1003 to calculate the reliability level of the estimated position. When the calculated reliability level is high, the radio terminal among radio terminals 101 to 104 stores in the storage as training data, the fingerprint input to the position estimation model and updates the position estimation model.

In step S1006, when communication is to end, radio terminals 101 to 105 end the process in the flowchart illustrated in FIG. 7. When communication is not to end, radio terminals 101 to 105 cause the process to return to step S1001 and perform the data obtaining process again.

FIG. 8 is a flowchart illustrating an example operation of the data obtaining process. The process in the flowchart illustrated in FIG. 8 corresponds to, for example, S1001 in the flowchart illustrated in FIG. 7. Although an example operation in radio terminal 101 will be described below, radio terminals 102 to 105 perform a similar operation.

In step S201, radio terminal 101 transmits a BC packet for RSSI measurement at predetermined intervals.

In step S202, radio terminal 101 measures the RSSIs of BC packets received from other radio terminals 102 to 105. Radio terminal 101 generates a fingerprint that is a set of the measured RSSIs and source addresses included in the respective BC packets and stores the fingerprint in storage 14.

In step S203, radio terminal 101 determines whether a save command is input by a user (for example, the installer of position estimation system 1) operating inputter-outputter 13, such as a switch. When a save command is not input (“No” in S203), radio terminal 101 causes the process to return to step S201. When a save command is input (“Yes” in S203), radio terminal 101 causes the process to proceed to step S204.

In step S204, radio terminal 101 stores in storage 14 as training data, the fingerprint stored in storage 14 in step S202. Radio terminal 101 uses the training data stored in storage 14 to generate a position estimation model.

For example, after position estimation system 1 is installed in a factory and before position estimation for radio terminal 105, which is a mobile node, is put in operation, a user (for example, the installer of position estimation system 1) moves to a position close to radio terminal 101, which is an anchor node, while carrying radio terminal 105. The user operates inputter-outputter 13 of radio terminal 101 and inputs a save command. In response to input of the save command, radio terminal 101 stores in storage 14 as training data, the fingerprint stored in step S202.

That is, radio terminal 101 stores a fingerprint having a high reliability level (a fingerprint obtained when radio terminal 105 is in proximity to radio terminal 101) in storage 14 as training data and generates a position estimation model.

Similarly, the user moves to other radio terminals 102 to 104, which are anchor nodes, and inputs a save command, and each of radio terminals 102 to 104 stores a fingerprint having a high reliability level in the storage as training data. Each of radio terminals 102 to 104 uses the training data stored in the storage to generate a position estimation model.

In step S205, when communication is to end, radio terminal 101 ends the process in the flowchart illustrated in FIG. 8. When communication is not to end, radio terminal 101 causes the process to return to step S201 and transmits a BC packet for RSSI measurement at predetermined intervals.

Note that generation of a position estimation model in step S204 may be performed each time training data is stored in storage 14 (each time a save command is input). Generation of a position estimation model in step S204 may be performed when a predetermined number of pieces of training data are stored in storage 14.

The order of transmission of a BC packet in step S201 (the order of transmission by radio terminals 101 to 105) may be a predetermined order or a random order.

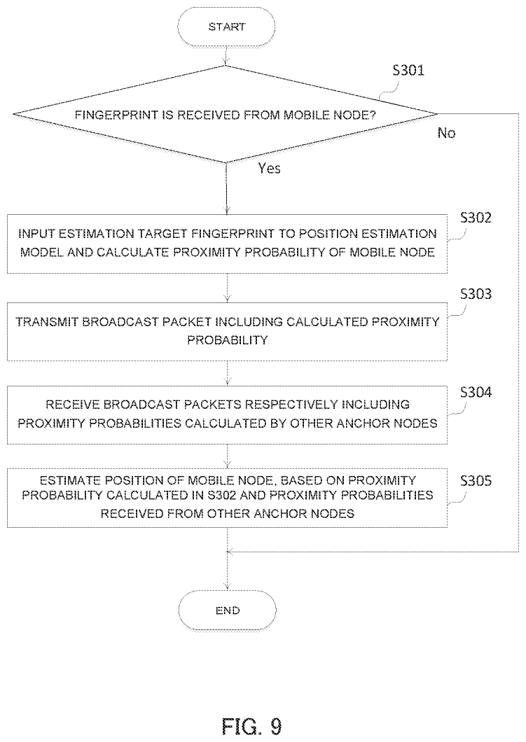

FIG. 9 is a flowchart illustrating an example general operation of the position estimation process. The process in the flowchart illustrated in FIG. 9 corresponds to, for example, S1002 and S1003 in the flowchart illustrated in FIG. 7. Although an example operation in radio terminal 101 will be described below, radio terminals 102 to 104 perform a similar operation.

In step S301, radio terminal 101 determines whether radio terminal 101 receives a fingerprint at radio terminal 105, which is a mobile node, from radio terminal 105. For example, radio terminal 101 determines whether radio terminal 101 receives BC packet 500 in which a fingerprint is stored in inquiry field 505 of BC packet 500 explained with reference to FIG. 6.

When radio terminal 101 does not receive a fingerprint (“No” in S301), radio terminal 101 ends the process in the flowchart illustrated in FIG. 9. When radio terminal 101 receives a fingerprint (“Yes” in S301), radio terminal 101 causes the process to proceed to step S302.

In step S302, radio terminal 101 inputs the received fingerprint to the position estimation model and calculates the proximity probability.

In step S303, radio terminal 101 includes the proximity probability calculated in step S302 in a BC packet and transmits the BC packet. For example, radio terminal 101 includes in response field 506, explained with reference to FIG. 6, of a BC packet, the proximity probability calculated in step S302, the source address of the source (the address of radio terminal 105) that transmits the fingerprint received in step S301, and the sequence number of the BC packet received in step S301, and transmits the BC packet.

In step S304, radio terminal 101 receives BC packets each including a proximity probability, from other radio terminals 102 to 104, which are anchor nodes. For example, radio terminal 101 receives BC packets 500 each including a proximity probability in response field 506 of BC packet 500 explained with reference to FIG. 6. That is, radio terminal 101 obtains proximity probabilities calculated by other radio terminals 102 to 104, which are anchor nodes.

In step S305, radio terminal 101 estimates the position of radio terminal 105, which is a mobile node, on the basis of the proximity probability calculated in step S302 and the proximity probabilities from other radio terminals 102 to 104, which are anchor nodes, obtained in S304. For example, radio terminal 101 infers that radio terminal 105, which is a mobile node, is located close to a radio terminal that is an anchor node and that calculates the highest proximity probability. After estimating the position of radio terminal 105, radio terminal 101 ends the process in the flowchart illustrated in FIG. 9.

Each of radio terminals 101 to 104, which are anchor nodes, performs the position estimation process in response to receiving a fingerprint from radio terminal 105, which is a mobile node. Radio terminal 105, which is a mobile node, also receives proximity probabilities from radio terminals 101 to 104, which are anchor nodes, and estimates the position of radio terminal 105. That is, in position estimation system 1, position estimation for radio terminal 105, which is a mobile node, is performed at a plurality of nodes.

Position estimation is performed at each of radio terminals 101 to 105, and therefore, any of radio terminals 101 to 105 can transmit the result of position estimation to, for example, another system, such as the production management server, or the user's terminal.

For example, a user who is the work manager of the factory operates a tablet terminal and makes an inquiry about the position of radio terminal 105, which is a mobile node, to the closest anchor node. Accordingly, the user can obtain the position of radio terminal 105.

Radio terminal 101 may make a comparison of reception strengths at a plurality of anchor nodes until a predetermined number of pieces of training data are stored in storage 14 and determine an anchor node at which the highest reception strength is measured to be a node in the vicinity of which the mobile node is located.

In each of radio terminals 101 to 104, which are anchor nodes, a plurality of position estimation models each having a predetermined parameter that is changed depending on the position estimation model may be installed. When the position estimation models are machine learning models using an algorithm, such as the K-Nearest Neighbor Algorithm or a random forest algorithm, the parameters of the plurality of position estimation models may be set such that the number of pieces of data to be referred to, the number and depths of decision trees, or the values of seeds for random numbers may be changed depending on the position estimation model.

When a plurality of position estimation models are installed in each of radio terminals 101 to 104, which are anchor nodes, as a proximity probability that is used to calculate the reliability level, for example, the average of a plurality of proximity probabilities calculated by using the plurality of position estimation models or the most common proximity probability among the plurality of proximity probabilities may be used.

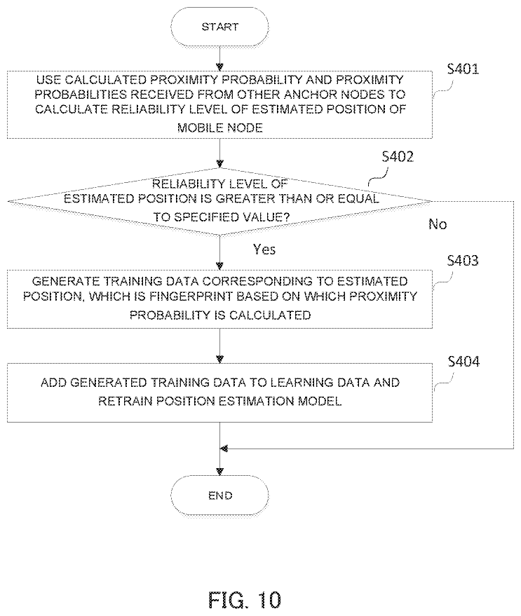

FIG. 10 is a flowchart illustrating an example general operation of the model update process. The process in the flowchart illustrated in FIG. 10 corresponds to, for example, S1004 and S1005 in the flowchart illustrated in FIG. 7. Although an example operation in radio terminal 101 will be described below, radio terminals 102 to 104 perform a similar operation.

In step S401, radio terminal 101 uses the proximity probability calculated by radio terminal 101 and the proximity probabilities received from other radio terminals 102 to 104, which are anchor nodes, to calculate the reliability level of the estimated position of radio terminal 105 estimated in step S305 in FIG. 9.

In step S402, radio terminal 101 determines whether the reliability level calculated in step S401 is greater than or equal to a specified value.

When the reliability level calculated in step S401 is less than the specified value (“No” in S402), radio terminal 101 ends the process in the flowchart illustrated in FIG. 10. When the reliability level calculated in step S401 is greater than or equal to the specified value (“Yes” in S402), radio terminal 101 causes the process to proceed to step S403.

In step S403, radio terminal 101 stores the fingerprint based on which the proximity probability is calculated, in storage 14 as training data generated when radio terminal 105, which is a mobile node, is present at the estimated position.

In step S404, radio terminal 101 retrains the position estimation model on the basis of the new training data stored in step S403 and past training data stored in storage 14. After retraining the position estimation model, radio terminal 101 ends the process in the flowchart illustrated in FIG. 10.

Each of radio terminals 101 to 104, which are anchor nodes, performs the process in the flowchart illustrated in FIG. 10 and stores as training data, a fingerprint based on which an estimated position of the target having a high reliability level is calculated. Accordingly, radio terminals 101 to 104 can update the respective position estimation models independently of each other so as to be highly accurate.

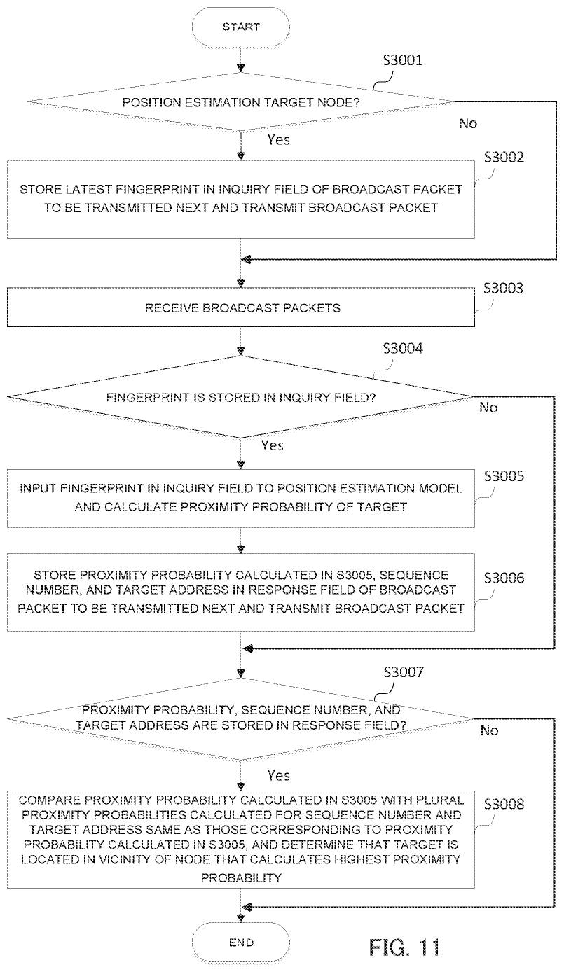

FIG. 11 is a flowchart illustrating an example operation of the position estimation process. The process in the flowchart illustrated in FIG. 11 corresponds to, for example, S301 to S305 in the flowchart illustrated in FIG. 9. Although the flowchart illustrated in FIG. 9 illustrates an example operation in radio terminals 101 to 104, which are anchor nodes, the flowchart illustrated in FIG. 11 includes an example operation in radio terminal 105, which is a mobile node. Each of radio terminals 101 to 105 will be referred to as the radio terminal below when the radio terminals are not distinguished from each other.

In step S3001, the radio terminal determines whether the radio terminal is a position estimation target node (mobile node). When the radio terminal is not a position estimation target node (when the radio terminal is an anchor node), the radio terminal causes the process to proceed to step S3003. When the radio terminal is a mobile node, the radio terminal causes the process to proceed to step S3002.

In step S3002, the radio terminal that is a position estimation target (the radio terminal that is a mobile node) stores the latest fingerprint in the inquiry field of a BC packet to be transmitted next and transmits the BC packet.

In step S3003, the radio terminal receives BC packets transmitted by the other radio terminals.

In step S3004, the radio terminal determines whether a fingerprint is stored in the inquiry field of any of the BC packets received in step S3003. When a fingerprint is not stored in the inquiry field of any of the received BC packets (“No” in S3004), the radio terminal causes the process to proceed to step S3007. When a fingerprint is stored in the inquiry field of any of the received BC packets (“Yes” in S3004), the radio terminal causes the process to proceed to step S3005.

In step S3005, the radio terminal that is an anchor node inputs the fingerprint stored in the inquiry field of the received BC packet to the position estimation model and calculates the proximity probability of the radio terminal that is a mobile node.

In step S3006, the radio terminal that is an anchor node stores the proximity probability calculated in step S3005 and the sequence number and the source address (the address of the radio terminal that is a mobile node) of the BC packet received in step S3003 and including the fingerprint, in the response field of a BC packet to be transmitted next and transmits the BC packet.

In step S3007, the radio terminal determines whether a proximity probability, a sequence number, and the address of a mobile node are stored in the response field of some of the BC packets received in step S3003. When a proximity probability, a sequence number, or the address of a mobile node is not stored in the response field of any of the BC packets received in step S3003 (“No” in S3007), the radio terminal ends the process in the flowchart illustrated in FIG. 11. When a proximity probability, a sequence number, and the address of a mobile node are stored in the response field of some of the BC packets received in step S3003 (“Yes” in S3007), the radio terminal causes the process to proceed to step S3008.

In step S3008, the radio terminal that is an anchor node compares the proximity probability calculated in step S3005 with proximity probabilities included in received BC packets that include a sequence number and a mobile node address the same as those corresponding to the proximity probability calculated in step S3005. The radio terminal that is an anchor node determines that the mobile node is located close to an anchor node that calculates the highest proximity probability. After determining the position of the radio terminal that is a mobile node, the radio terminal that is an anchor node ends the process in the flowchart illustrated in FIG. 11.

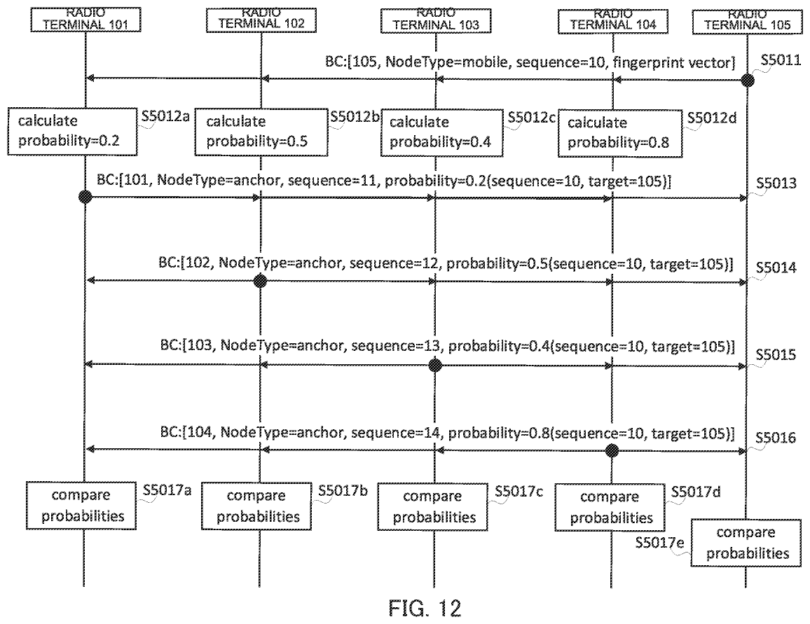

FIG. 12 is a sequence chart illustrating example operations in position estimation system 1. The processes in the sequence illustrated in FIG. 12 correspond to, for example, S3001 to S3008 in the flowchart illustrated in FIG. 11. In the example sequence in FIG. 12, radio terminal 105, which is a mobile node, is located in the vicinity of radio terminal 104, which is an anchor node.

In step S5011, radio terminal 105, which is a mobile node, transmits a BC packet.

In the destination address of the BC packet, the broadcast address is included. In the source address of the BC packet, the address of radio terminal 105, which is a mobile node, is included. In the node type of the BC packet, information indicating a mobile node is included. In the sequence number of the BC packet, for example, 10 is included. In the inquiry field of the BC packet, the latest fingerprint at radio terminal 105 is included.

In step S5012a, radio terminal 101, which is an anchor node, confirms that the fingerprint is stored in the inquiry field of the BC packet transmitted in step S5011.

After confirming that the fingerprint is stored, radio terminal 101 inputs the fingerprint to the position estimation model stored in storage 14 of radio terminal 101 and calculates the proximity probability that is the probability of the proximity of radio terminal 105 to radio terminal 101. Here, radio terminal 101 calculates the proximity probability to be, for example, “0.2”. Radio terminal 101 stores a set of the calculated proximity probability, the sequence number (10) of the BC packet based on which the proximity probability is calculated, and the address (for example, 105) of radio terminal 105 in storage 14.

In steps S5012b to S5012d, each of radio terminals 102 to 104, which are anchor nodes, calculates and stores in the storage, the proximity probability of radio terminal 105, which is a mobile node, as in step S5012a.

Radio terminal 102 calculates the proximity probability to be, for example, “0.5”. Radio terminal 103 calculates the proximity probability to be, for example, “0.4”. Radio terminal 104 calculates the proximity probability to be, for example, “0.8”.

The sequence number of the BC packet received in step S5011 is used to, for example, identify a fingerprint based on which the proximity probability is calculated a plurality of times.

The address of the mobile node may be, for example, the source address of the received BC packet or may be information for identifying the mobile node separately stored in the broadcast packet.

In step S5013, radio terminal 101, which is an anchor node, transmits a BC packet. In the source address of the BC packet, the address (for example, 101) of radio terminal 101 is included. In the response field of the BC packet, the proximity probability (0.2), the sequence number (10), and the address (105) of the mobile node stored in the storage in step S5012a are included.

Radio terminals 102 to 105 receive the BC packet transmitted by radio terminal 101. Each of radio terminals 102 to 105 that receives the BC packet stores in the storage, a set of the source address (101) of the received BC packet and the pieces of information included in the response field.

In step S5014, radio terminal 102, which is an anchor node, transmits a BC packet.

In the source address of the BC packet, the address (for example, 102) of radio terminal 102 is included. In the response field of the BC packet, the proximity probability (0.5), the sequence number (10), and the address (105) of the mobile node stored in the storage in step S5012b are included.

Radio terminals 101 and 103 to 105 receive the BC packet transmitted by radio terminal 102. Each of radio terminals 101 and 103 to 105 that receives the BC packet stores in the storage, a set of the source address (102) of the received BC packet and the pieces of information included in the response field.

In step S5015, radio terminal 103, which is an anchor node, transmits a BC packet. In the source address of the BC packet, the address (for example, 103) of radio terminal 103 is included. In the response field of the BC packet, the proximity probability (0.4), the sequence number (10), and the address (105) of the mobile node stored in the storage in step S5012c are included.

Radio terminals 101, 102, 104, and 105 receive the BC packet transmitted by radio terminal 103. Each of radio terminals 101, 102, 104, and 105 that receives the BC packet stores in the storage, a set of the source address (103) of the received BC packet and the pieces of information included in the response field.

In step S5016, radio terminal 104, which is an anchor node, transmits a BC packet. In the source address of the BC packet, the address (for example, 104) of radio terminal 104 is included. In the response field of the BC packet, the proximity probability (0.8), the sequence number (10), and the address (105) of the mobile node stored in the storage in step S5012d are included.

Radio terminals 101 to 103 and 105 receive the BC packet transmitted by radio terminal 104. Each of radio terminals 101 to 103 and 105 that receives the BC packet stores in the storage, a set of the source address (104) of the received BC packet and the pieces of information included in the response field.

In the BC packet transmission processes in steps S5013 to S5016, radio terminals 101 to 105 share the proximity probabilities calculated by radio terminals 101 to 104, which are anchor nodes.

In step S5017a, radio terminal 101 obtains, among the pieces of information in the response field stored in storage 14, proximity probabilities corresponding to a sequence number and a source address the same as the sequence number (10) and the source address (105) of the BC packet received in S5011. In other words, radio terminal 101 obtains proximity probabilities calculated on the basis of the same fingerprint of the same mobile node (the fingerprint in the BC packet transmitted in S5011).

Radio terminal 101 compares the obtained proximity probabilities with each other. For example, radio terminal 101 compares the proximity probability “0.2” calculated by radio terminal 101, the proximity probability “0.5” calculated by radio terminal 102, the proximity probability “0.4” calculated by radio terminal 103, and the proximity probability “0.8” calculated by radio terminal 104 with each other. Radio terminal 101 determines that radio terminal 105, which is a mobile node, is located in the vicinity of radio terminal 104 that calculates the highest proximity probability “0.8”.

In steps S5017b to S5017e, radio terminals 102 to 105 determine the position of radio terminal 105, which is a mobile node, as in step S5017a. Each of radio terminals 102 to 105 obtains proximity probabilities the same as those obtained by radio terminal 101, and therefore, obtains a determination result the same as that obtained by radio terminal 101.

Note that each of radio terminals 101 to 105 may compare proximity probabilities with each other at a timing when the number of stored proximity probabilities reaches a predetermined number or at predetermined intervals.

Each radio terminal of radio terminals 101 to 105 may compare proximity probabilities each time the radio terminal receives a BC packet in which a proximity probability, a sequence number, and a target node address are stored in the response field and may store response information that includes a higher proximity probability in the response field of a BC packet to be transmitted next. At this time, the node address of a radio terminal that calculates the higher proximity probability may be included in the response information.

For example, in FIG. 12, after receiving the BC packet from radio terminal 102 in step S5014, radio terminal 101 causes the process to proceed to step S5017a. Radio terminal 101 compares the proximity probability 0.5 included in the received BC packet with the proximity probability 0.2 calculated by radio terminal 101, determines the position of radio terminal 105 at this time point, and performs the model update process. Further, radio terminal 101 stores response information that includes the higher proximity probability 0.5 and the node address of radio terminal 102 that calculates the higher proximity probability in the response field of a BC packet to be transmitted next and transmits the BC packet.

Accordingly, each radio terminal can update its position estimation model before obtaining proximity probabilities from all the other radio terminals.

When each radio terminal of radio terminals 101 to 105 receives a plurality of proximity probabilities from one anchor node within a predetermined time, the radio terminal may calculate the average of the plurality of proximity probabilities or obtain the maximum value among the plurality of proximity probabilities and may compare the average or the maximum value with proximity probabilities from the other anchor nodes.

When, for example, radio terminal 101 receives again an inquiry in a BC packet from radio terminal 105 at a certain time between step S5012a and step S5017a, radio terminal 101 may compare the average of or the maximum value among a proximity probability calculated again and the proximity probability calculated in step S5012a with proximity probabilities calculated by the other anchor nodes.

Accordingly, the position of the mobile node can be determined while variations due to the time when the proximity probability is calculated (calculation timing) is reduced.

The timing when a radio terminal transmits a BC packet in which the proximity probability is stored in the response field may be a timing when the radio terminal receives a proximity probability from another node and compares the proximity probabilities with each other. The timing when a radio terminal transmits a BC packet in which the proximity probability is stored in the response field may be a timing when the radio terminal has a turn performing transmission in accordance with a predetermined order.

When calculating a proximity probability, each of radio terminals 101 to 105 may input to the position estimation model, a fingerprint stored in the inquiry field of a BC packet received at a preceding time together with a fingerprint for estimation.

For example, radio terminal 101 that receives the BC packet transmitted in step S5011 may input to the position estimation model, in addition to the fingerprint stored in the inquiry field of the received BC packet having the sequence number “10”, fingerprints stored in the respective inquiry fields of one or more BC packets having a sequence number other than “10” among BC packets transmitted from radio terminal 105, and may calculate the proximity probability.

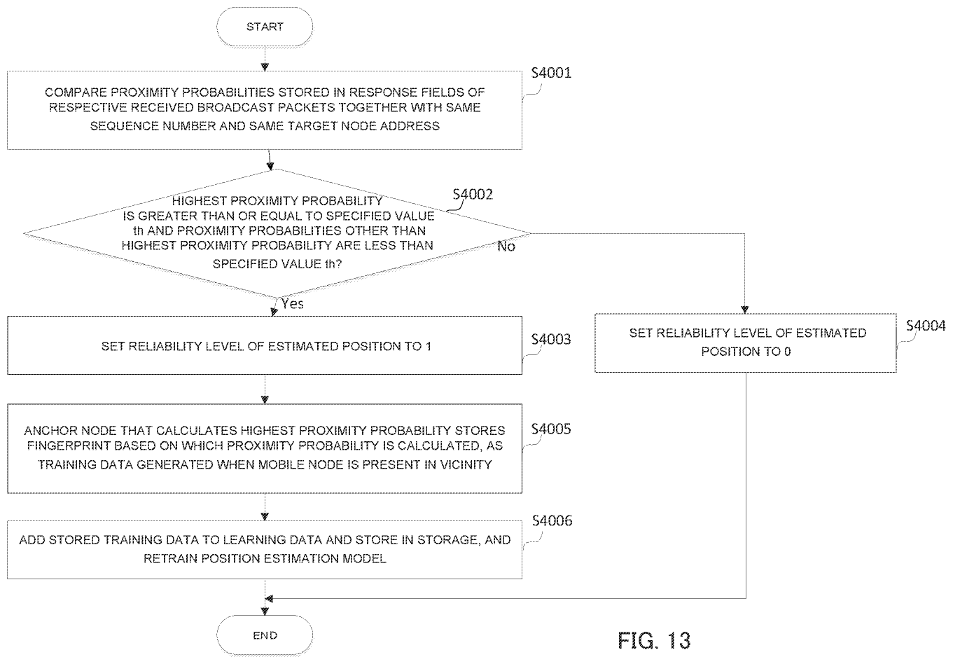

FIG. 13 is a flowchart illustrating an example update operation of updating a position estimation model. The process in the flowchart illustrated in FIG. 13 corresponds to, for example, S401 to S404 in the flowchart illustrated in FIG. 10. Each of radio terminals 101 to 104 will be referred to as the radio terminal below when the radio terminals are not distinguished from each other.

In step S4001, the radio terminal that is an anchor node obtains proximity probabilities corresponding to a sequence number and a mobile node address the same as a sequence number and a mobile node address corresponding to a fingerprint used in calculation of the proximity probability by the radio terminal, among proximity probabilities from the other radio terminals stored in the storage. The radio terminal that is an anchor node compares the proximity probability calculated by the radio terminal with the obtained proximity probabilities.

In step S4002, the radio terminal that is an anchor node determines whether the value of the highest proximity probability among the proximity probabilities compared in step S4001 is greater than or equal to a specified value th and the values of proximity probabilities other than the highest proximity probability are less than a specified value th.

When the value of the highest proximity probability among the proximity probabilities compared in step S4001 is less than the specified value th or the values of proximity probabilities other than the highest proximity probability are greater than or equal to the specified value th (“No” in S4002), the radio terminal that is an anchor node causes the process to proceed to step S4004. When the value of the highest proximity probability among the proximity probabilities compared in step S4001 is greater than or equal to the specified value th and the values of proximity probabilities other than the highest proximity probability are less than the specified value th (“Yes” in S4002), the radio terminal that is an anchor node causes the process to proceed to step S4003.

In step S4003, the radio terminal that is an anchor node sets the reliability level of the estimated position to “1” and causes the process to proceed to step S4005.

In step S4004, the radio terminal that is an anchor node sets the reliability level of the estimated position to “0” and ends the process in the flowchart illustrated in FIG. 13.

In step S4005, the anchor node that calculates the highest proximity probability stores a fingerprint based on which the proximity probability is calculated (a fingerprint that is input to the position estimation model) in the storage as training data.

In step S4006, the radio terminal that is an anchor node uses the training data stored in the storage to retrain and update the position estimation model.

Note that in step S4002, the specified value th that is compared with the highest proximity probability and the specified value th that is compared with proximity probabilities other than the highest proximity probability may have different values or the same values.

In step S4005, the radio terminal that is an anchor node other than the anchor node that calculates the highest proximity probability may save a fingerprint based on which the proximity probability is calculated, in the storage as training data generated when the radio terminal that is a mobile node is not in the vicinity of the radio terminal that is an anchor node.

When calculating the reliability level R_t of an estimated position of a target at a certain time T, the radio terminal that is an anchor node may use an estimated position of the target at a certain time (t−Δt) that is before the time t or the reliability level R_(t−Δt) of the estimated position. At is any time that is relatively short.

When calculating the reliability level R_t of an estimated position of a target at the certain time t, the radio terminal that is an anchor node may use a proximity probability calculated by each radio terminal in order to estimate the position of the target at the certain time (t−Δt) that is before the time t.

When determining a reliability level, the radio terminal that is an anchor node may classify the value of the reliability level as 0 or 1 on the basis of a result obtained by inputting a plurality of proximity probabilities to, for example, a classification model based on machine learning using a random forest.

The radio terminal that is an anchor node may calculate a reliability level as a value within a range from 0 to 1 on the basis of a result obtained by inputting the values of a plurality of proximity probabilities to, for example, a regression model based on machine learning using logistic regression. When the reliability level is greater than or equal to a predetermined value, the radio terminal that is an anchor node may store the fingerprint in the storage as training data.

The radio terminal that is an anchor node may refer to installation place information about the fixed places of all the anchor nodes, and when the last estimated position of the target is close to the position of the radio terminal, the radio terminal that is an anchor node may weight the proximity probability calculated by the radio terminal and determine the reliability level. The radio terminal that is an anchor node may store in the storage, installation place information about all the anchor nodes or about another anchor node placed close to the radio terminal or may periodically transmit a BC packet in which installation position information about the radio terminal is stored.

As described above, position estimation system 1 includes radio terminal 105, which is a mobile node, and radio terminals 101 to 104, which are anchor nodes in each of which a learning model is installed. Radio terminal 105, which is a mobile node, broadcasts to radio terminals 101 to 104, a fingerprint that indicates the reception strength distribution of radio signals from radio terminals 101 to 104. Each radio terminal of radio terminals 101 to 104, which are anchor nodes, inputs the fingerprint to the learning model, calculates the proximity probability that is the probability of the proximity of radio terminal 105 to the radio terminal, and broadcasts the proximity probability to the other radio terminals of radio terminals 101 to 105. Each of radio terminals 101 to 105 uses the broadcast proximity probabilities to estimate the position of radio terminal 105.

Accordingly, position estimation system 1 can estimate the position of radio terminal 105, which is a mobile node, at low cost without using, for example, another apparatus such as a camera. Further, position estimation system 1 can estimate the position of radio terminal 105 with high accuracy by using a learning model.

(Variation 1)

Although radio terminals 101 to 104 store a fingerprint in the storage as training data in response to an operation for a save command performed by a user using the inputter-outputter, the embodiment is not limited to this.

For example, each radio terminal of radio terminals 101 to 104 may detect, with a motion detector, a user carrying radio terminal 105 being located in the vicinity of the radio terminal and store a fingerprint in the storage as training data.

The inputter-outputter of radio terminal 105 may accept a user operation for storing a fingerprint as training data. For example, in response to the inputter-outputter accepting a user operation, radio terminal 105 transmits a fingerprint save command to radio terminals 101 to 104. Radio terminals 101 to 104 store training data in the storage in accordance with the fingerprint save command transmitted from radio terminal 105.

Radio terminal 105 may, for example, output a predetermined signal having a short communication range (communication area), such as a communication range (communication area) of 1 m to 2 m. In response to receiving the predetermined signal from radio terminal 105, radio terminals 101 to 104 may store a fingerprint in the storage as training data.

(Variation 2)

Radio terminal 105, which is a mobile node, may store a fingerprint that is training data in the storage. When storing a fingerprint that is training data in the storage, radio terminal 105 may store the fingerprint so as to be linked with the address of a radio terminal located in the vicinity of radio terminal 105, among radio terminals 101 to 104, which are anchor nodes. For example, an optional region may be provided in the data format of a fingerprint (see, for example, FIG. 2), and the address of the radio terminal among radio terminals 101 to 104, which are anchor nodes, may be stored in the optional region.

Accordingly, pieces of training data stored when radio terminal 105 is present in the vicinity of radio terminals 101 to 104 are stored for radio terminals 101 to 104 separately. Determination as to whether radio terminal 105 is present in the vicinity of radio terminals 101 to 104 may be performed with a method the same as that in Variation 1.

Note that the addresses of radio terminals 101 to 104 may be communicated to radio terminal 105 such that a radio terminal that issues a save command for saving a fingerprint, among radio terminals 101 to 104, transmits a packet to radio terminal 105.

The addresses of radio terminals 101 to 104 may be given through the inputter-outputter of radio terminal 105 as a parameter of a save command for saving a fingerprint.

In response to the issuance of a save command for saving a fingerprint, each radio terminal of radio terminals 101 to 104 stores as training data, a fingerprint obtained when radio terminal 105 is located in the vicinity of the radio terminal. Radio terminal 105 stores pieces of training data stored when radio terminal 105 is present in the vicinity of radio terminals 101 to 104, for radio terminals 101 to 104 separately.

Radio terminal 105, which is a mobile node, may save in the storage, pieces of training data for radio terminals 101 to 104, which are anchor nodes, separately to thereby generate a position estimation model for calculating a proximity probability for each of radio terminals 101 to 104. Accordingly, radio terminal 105, which is a mobile node, can determine in the vicinity of which anchor node radio terminal 105 is located, on the basis of the pieces of training data saved in the storage.

Note that when a radio terminal having the highest proximity probability among proximity probabilities calculated by radio terminal 105 in the position estimation process and a radio terminal having the highest proximity probability among proximity probabilities calculated by radio terminals 101 to 104 in the position estimation process match each other, the proximity probability may be weighted.

Radio terminal 105 may update a position estimation model. For example, when the highest degree of proximity is greater than or equal to the first specified value and all the other degrees of proximity (degrees of proximity other than the highest degree of proximity) are less than the second specified value, radio terminal 105 may update a position estimation model corresponding to the radio terminal that is an anchor node calculating the highest degree of proximity, by using the fingerprint as training data.

(Variation 3)

When each radio terminal of radio terminals 101 to 105 updates a fingerprint and when a source address that forms a set with an RSSI to be added is already included in the fingerprint, the radio terminal may overwrite the fingerprint with the newly measured RSSI as needed. When each radio terminal of radio terminals 101 to 105 updates a fingerprint and when a source address and a destination address that form a set with an RSSI to be added are already included in the fingerprint, the radio terminal may overwrite the fingerprint with the newly measured RSSI as needed. Each of radio terminals 101 to 105 may store two or more fingerprints while using sequence numbers stored in the BC packets as identifiers.

(Variation 4)

When updating a fingerprint, radio terminals 101 to 105 may receive a fingerprint that includes RSSIs older than the RSSIs in the fingerprint stored at the time point.

Therefore, radio terminals 101 to 105 may store a sequence number in addition to source addresses and RSSIs. When updating a fingerprint, radio terminals 101 to 105 may compare the sequence number of the fingerprint stored in the storage with the sequence number of a newly received fingerprint and update the fingerprint by using newly measured RSSIs.

(Variation 5)

In response to the issuance of a save command for saving a plurality of fingerprints, radio terminals 101 to 105 may calculate the averages of a plurality of RSSIs corresponding to the save command for saving a plurality of fingerprints and store the averages of the RSSIs in the storage as training data.

Note that a radio terminal that is not a radio terminal closest to radio terminal 105, among radio terminals 101 to 104, may receive a save command for saving a fingerprint and store the current fingerprint as optional training data in place of the closest node.

In this case, the radio terminal that is not a radio terminal closest to radio terminal 105, among radio terminals 101 to 104, may store the address of the closest radio terminal in the optional training data. Accordingly, the fingerprint that is stored as the training data can be identified as training data stored when radio terminal 105 is present closest to which of radio terminals 101 to 104, by using the address of the closest node stored as the option.

(Variation 6)

Regarding storing of training data, to specify to what extent old training data is to be stored, a predetermined time may be set for each node or a user may input a predetermined time as a parameter as needed.

In the embodiment described above, the expression “ . . . er” or “ . . . or” used to express each configuration element may be replaced by another expression, such as “ . . . circuit (circuitry)”, “ . . . assembly”, “ . . . device”, “ . . . unit”, or a “ . . . module”. The training data described above may be referred to as “ground truth data” or “ground truth value”. The position estimation model may be referred to as “AI model” or “AI prediction model”. As a matter of course, the training data and the position estimation model is not limited to be referred to as described above.

Hereinabove, the embodiment has been described with reference to the drawings, the present disclosure is not limited to such examples. It will be apparent to those skilled in the art may arrive at various modifications or variations at within the scope of the claims, and it is naturally understood that the various modifications or variations are also within the technical scope of the present disclosure. In addition, the components in the above embodiments may be optionally combined without departing from the spirit and scope of the present disclosure.

The present disclosure can be realized by software, hardware, or software in cooperation with hardware. Each functional block used in the description of the embodiment described above can be partly or entirely realized by an LSI such as an integrated circuit, and each process described in the embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas. Some non-limiting examples of such a communication apparatus include a phone (e.g, cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

(Summary of Present Disclosure)

A position estimation system according to the present disclosure, includes: a mobile radio apparatus; and a plurality of fixed radio apparatuses in which a learning model is installed, in which the mobile radio apparatus transmits, to the plurality of fixed radio apparatuses, a fingerprint that indicates a reception strength distribution of radio signals from the plurality of fixed radio apparatuses, and each of the plurality of fixed radio apparatuses inputs the fingerprint to the learning model and transmits a degree of proximity of the mobile radio apparatus output from the learning model to another one or more of the plurality of fixed radio apparatuses, and each of the plurality of fixed radio apparatuses determines a position of the mobile radio apparatus, based on a first degree of proximity output from the learning model and a second degree of proximity received from the other one or more of the plurality of fixed radio apparatuses.

In the position estimation system according to the present disclosure, at least one of the plurality of fixed radio apparatuses at which the first degree of proximity is highest among the plurality of fixed radio apparatuses updates the learning model by using the fingerprint as training data.

In the position estimation system according to the present disclosure, the at least one of the plurality of fixed radio apparatuses at which the first degree of proximity is highest calculates a reliability level of the determined position of the mobile radio apparatus, based on the degree of proximity output from the learning model and the degree of proximity transmitted from another one or more of the plurality of fixed radio apparatuses, and updates, based on the reliability level, the learning model by using the fingerprint as training data.

In the position estimation system according to the present disclosure, the at least one of the plurality of fixed radio apparatus at which the first degree of proximity is highest uses the fingerprint as training data when the first degree of proximity is greater than or equal to a first specified value and every one of a plurality of the second degrees of proximity is less than a second specified value.

In the position estimation system according to the present disclosure, the mobile radio apparatus receives the first degree of proximity and the second degree of proximity and determines the position of the mobile radio apparatus.

In the position estimation system according to the present disclosure, in the mobile radio apparatus, a learning model that outputs a degree of proximity to each of the plurality of fixed radio apparatuses is installed.

In the position estimation system according to the present disclosure, the mobile radio apparatus updates the learning model in at least one of the plurality of fixed radio apparatus at which the degree of proximity is highest among the plurality of fixed radio apparatuses by using the fingerprint as training data.

A fixed radio apparatus according to the present disclosure, includes: a communication circuit that receives from a mobile radio apparatus, a fingerprint that indicates a reception strength distribution of a radio signal from the fixed radio apparatus and a radio signal from another fixed radio apparatus; and a control circuit that inputs the fingerprint to a learning model and obtains a first degree of proximity of the mobile radio apparatus to the fixed radio apparatus, in which the communication circuit receives a second degree of proximity of the mobile radio apparatus to the other fixed radio apparatus, the second degree of proximity being obtained by the other fixed radio apparatus by inputting the fingerprint to a learning model, and the control circuit determines a position of the mobile radio apparatus, based on the first degree of proximity and the second degree of proximity.

A mobile radio apparatus according to the present disclosure, includes: a communication circuit that transmits to a plurality of fixed radio apparatuses, a fingerprint that indicates a reception strength distribution of radio signals from the plurality of fixed radio apparatuses, and receives from the plurality of fixed radio apparatuses, degrees of proximity of the mobile radio apparatus to the plurality of fixed radio apparatuses, the degrees of proximity being obtained by the plurality of fixed radio apparatuses by inputting the fingerprint to respective learning models; and a control circuit that determines a position of the mobile radio apparatus, based on the degrees of proximity.

The disclosure of Japanese Patent Application No. 2020-163244 filed on Sep. 29, 2020 including the specification, drawings and abstract is incorporated herein by reference in its entirety.

### INDUSTRIAL APPLICABILITY

The present disclosure is applicable to a position estimation system using a fingerprint of radio communication.

### REFERENCE SIGNS LIST

1 Position estimation system
11 Radio communicator
12 Controller
13 Inputter-outputter
14 Storage
21 Data obtainer
22 Position estimator
22a Proximity probability calculator
22b Position determiner
23 Model updater
23a Reliability level determiner
23b Training data generator
23c Model trainer
101 to 105 Radio terminal

1. A position estimation system, comprising:
a mobile radio apparatus; and
a plurality of fixed radio apparatuses in which a learning model is installed, wherein
the mobile radio apparatus transmits, to the plurality of fixed radio apparatuses, a fingerprint that indicates a reception strength distribution of radio signals from the plurality of fixed radio apparatuses, and
each of the plurality of fixed radio apparatuses inputs the fingerprint to the learning model and transmits a degree of proximity of the mobile radio apparatus output from the learning model to another one or more of the plurality of fixed radio apparatuses, and
each of the plurality of fixed radio apparatuses determines a position of the mobile radio apparatus, based on a first degree of proximity output from the learning model and a second degree of proximity received from the other one or more of the plurality of fixed radio apparatuses.

2. The position estimation system according to claim 1, wherein
at least one of the plurality of fixed radio apparatuses at which the first degree of proximity is highest among the plurality of fixed radio apparatuses updates the learning model by using the fingerprint as training data.

3. The position estimation system according to claim 2, wherein
the at least one of the plurality of fixed radio apparatuses at which the first degree of proximity is highest calculates a reliability level of the determined position of the mobile radio apparatus, based on the degree of proximity output from the learning model and the degree of proximity transmitted from another one or more of the plurality of fixed radio apparatuses, and updates, based on the reliability level, the learning model by using the fingerprint as training data.

4. The position estimation system according to claim 2, wherein
the at least one of the plurality of fixed radio apparatus at which the first degree of proximity is highest uses the fingerprint as training data when the first degree of proximity is greater than or equal to a first specified value and every one of a plurality of the second degrees of proximity is less than a second specified value.

5. The position estimation system according to claim 1, wherein
the mobile radio apparatus receives the first degree of proximity and the second degree of proximity and determines the position of the mobile radio apparatus.

6. The position estimation system according to claim 1, wherein
in the mobile radio apparatus, a learning model that outputs a degree of proximity to each of the plurality of fixed radio apparatuses is installed.

7. The position estimation system according to claim 6, wherein
the mobile radio apparatus updates the learning model in at least one of the plurality of fixed radio apparatus at which the degree of proximity is highest among the plurality of fixed radio apparatuses by using the fingerprint as training data.

8. A fixed radio apparatus, comprising:
a communication circuit that receives from a mobile radio apparatus, a fingerprint that indicates a reception strength distribution of a radio signal from the fixed radio apparatus and a radio signal from another fixed radio apparatus; and
a control circuit that inputs the fingerprint to a learning model and obtains a first degree of proximity of the mobile radio apparatus to the fixed radio apparatus, wherein
the communication circuit receives a second degree of proximity of the mobile radio apparatus to the other fixed radio apparatus, the second degree of proximity being obtained by the other fixed radio apparatus by inputting the fingerprint to a learning model, and
the control circuit determines a position of the mobile radio apparatus, based on the first degree of proximity and the second degree of proximity.

9. A mobile radio apparatus, comprising:
a communication circuit that transmits to a plurality of fixed radio apparatuses, a fingerprint that indicates a reception strength distribution of radio signals from the plurality of fixed radio apparatuses, and receives from the plurality of fixed radio apparatuses, degrees of proximity of the mobile radio apparatus to the plurality of fixed radio apparatuses, the degrees of proximity being obtained by the plurality of fixed radio apparatuses by inputting the fingerprint to respective learning models; and
a control circuit that determines a position of the mobile radio apparatus, based on the degrees of proximity.
